(19) United States
(12) Patent Application Publication
(10) Pub. No.: US 2007/0092022 A1
(43) Pub. Date: Apr. 26, 2007

(54) Integrated frequency shift-keying FSK transceiver

(75) Inventors: Stephen E. Krafft, Los Angeles, CA (US); Daniel Richard, Pasadena, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/586,667

(22) Filed: Oct. 26, 2006

Related U.S. Application Data
(60) Provisional application No. 60/730,149, filed on Oct. 26, 2005.

(51) Int. Cl. H04L 27/10

(52) U.S. Cl. 375/272

(57) ABSTRACT

An integrated frequency-shift keying (FSK) transceiver fabricated on an integrated circuit (IC) chip. The integrated FSK transceiver provides a bidirectional exchange of information between a satellite set-top box converter or modem and one or more outdoor units (ODUs). The integrated FSK transceiver includes a binary FSK receiver coupled to one or more translation modules of associated satellite antennas. The FSK receiver provides management information transmitted from the translation modules to a baseband interface. The baseband interface provides connectivity between the translation modules and the satellite converter set-top box and/or data modem. A binary FSK transmitter transmits management information generated by the baseband interface to the translation modules.

### CROSS-REFERENCE TO RELATED APPLICATIONS

This application claims benefit to U.S. Provisional Application No. 60/730,149, filed Oct. 26, 2005, which is incorporated herein by reference in its entirety.

### BACKGROUND OF THE INVENTION

1. Field of the Invention

The present invention generally relates to communications between a set-top box and outdoor units such as satellite antennas. More specifically, the present invention relates to bidirectional exchanges of information between a satellite set-top box and one or more satellite antennas.

2. Background Art

Satellite set-top boxes are often configured to communicate with one or more satellite antennas. As satellite receivers, within the set-top boxes, have evolved, a diverse range of management information can now be exchanged with the set-top box. The sophistication of these exchanges, however, remains limited by the ability of the satellite to accommodate communication via one or more antennas.

Early management communication systems provided a one-way communication link from the satellite antenna to the set-top box. To date, bidirectional communication systems are largely unsophisticated. Further, these systems are implemented using expensive and bulky analog components on a printed circuit board (PCB), thereby greatly increasing the cost of the set-top box.

What is needed, therefore, is a communications system that can efficiently accommodate bidirectional exchanges of information between a satellite set-top boxes and one or more satellite antennas.

### BRIEF SUMMARY OF THE INVENTION

Consistent with the principles of the present invention, as embodied and broadly described herein, the present invention includes an integrated frequency-shift keying (FSK) transceiver. The transceiver includes an FSK receiver and a baseband interface coupled to the FSK receiver. An FSK transmitter is coupled to the baseband interface. The FSK receiver, the baseband interface, and the FSK transmitter are formed on a single integrated circuit.

In the present invention, the integrated frequency-shift keying (FSK) transceiver enables the bidirectional exchange of information between a satellite set-top box converter and/or data modem and one or more satellite antennas. In another embodiment, the invention enables bidirectional exchange of information between a cable set top box and a cable headend.

Additionally, the invention provides an integrated frequency-shift keying (FSK) transceiver fabricated on an integrated circuit (IC) chip. In one embodiment, the integrated FSK transceiver provides the bidirectional exchange of information between a satellite set-top box converter or modem and one or more outdoor units (ODUs). The integrated FSK transceiver includes a binary FSK receiver coupled to one or more translation modules of associated satellite antennas. The FSK receiver provides management information transmitted from the translation modules to a baseband interface. The baseband interface provides connectivity between the translation modules and the satellite converter set-top box and/or data modem. A binary FSK transmitter transmits management information generated by the baseband interface to the translation modules. As a result of the facilitated bidirectional communication between the set-top box and the outdoor unit, a robust communication system is provided that costs less to manufacture and operate.

Additional features and advantages of the invention will be set forth in the description that follows, and in part will be apparent from the description, or may be learned by practice of the invention. The advantages of the invention will be realized and attained by the structure and particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS/FIGURES

The accompanying drawings illustrate the present invention and, together with the description, further serve to explain the principles of the invention and to enable one skilled in the pertinent art to make and use the invention.

FIG. 1 illustrates a satellite receiver system.

FIG. 2 illustrates an integrated frequency-shift keying (FSK) transceiver of the present invention.

### DETAILED DESCRIPTION OF THE INVENTION

The following detailed description of the present invention refers to the accompanying drawings that illustrate exemplary embodiments consistent with this invention. Other embodiments are possible, and modifications may be made to the embodiments within the spirit and scope of the invention. Therefore, the following detailed description is not meant to limit the invention. Rather, the scope of the invention is defined by the appended claims.

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

It would be apparent to one skilled in the art that the present invention, as described below, may be implemented in many different embodiments of hardware and/or the entities illustrated in the drawings. Thus, the operation and behavior of the present invention will be described with the understanding that modifications and variations of the embodiments are possible, given the level of detail presented herein.

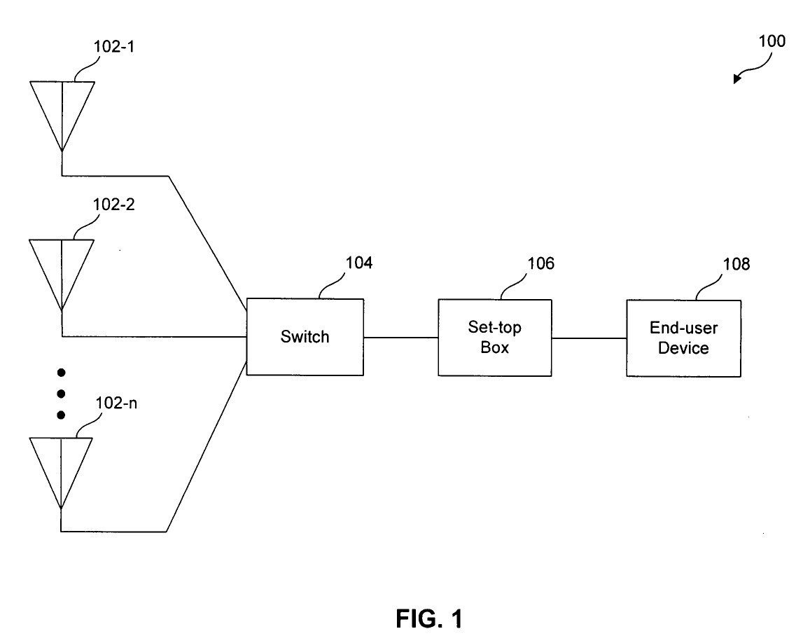

FIG. 1 illustrates a satellite receiver system 100. The satellite receiver system 100 includes a number of antennas 102-1 through 102-n, a switch 104, a set-top box 106 and an end-user device 108. The set-top box 106 can be, for example, a satellite modem for decoding data communication signals or a satellite television converter for decoding media signals. Accordingly, the end-user device 108 can be, for example, a computer or a television.

The switch 104 is used to switch among the antennas or outdoor units (ODUs) 102-1 through 102-n. The switch 104 can also be used to select a polarization of each of the ODUs 102-1 through 102-n. To minimize the amount of cabling required to support the ODUs 102-1 through 102-n, the switch 104 and the ODUs 102-1 through 102-n are located outside of a domicile. The set-top box 106 and the end-user device 108 are typically located within a domicile. The polarization setting and antenna switching functionality of the switch 104 can alternatively be incorporated into one or more of the ODUs 102-1 through 102-n, thereby obviating the need for a separate switch element 104.

For effective management and operation of the satellite receiver system 100, bidirectional communication between the set-top box 106 and the switch 104 and/or the ODUs 102-1 through 102-n is used. Bidirectional communication enables the set-top box 106 to exchange management and status information with the switch 104 and/or the ODUs 102-1 through 102-n. Information exchanged may also include frequency band selections on each antenna, antenna status, and mechanical antenna tracking.

Many communication systems enabling the bidirectional exchange of management information between the ODUs 102-1 through 102-n and the set-top box 106 are largely unsophisticated. For example, a prior system enables the set-top box 106 to transmit two bits to the ODUs 102-1 through 102-n. The first bit (either 13V or 18V) is used to select an antenna and the second bit (a 22 kHz tone) is used to select a polarization. Further, many of these prior systems are implemented on a printed circuit board (PCB) using several expensive and bulky discrete analog components that greatly increase the cost of the set-top box 106.

As the ODUs 102-1 through 102-n have evolved, a diverse range of information can now be exchanged with the set-top box 106. Accordingly, there is a need for a more robust communication system to enable the exchange of large amounts of data between the set-top box 106 and the ODUs 102-1 through 102-n. Further, the communication system should be fast, reliable and low cost.

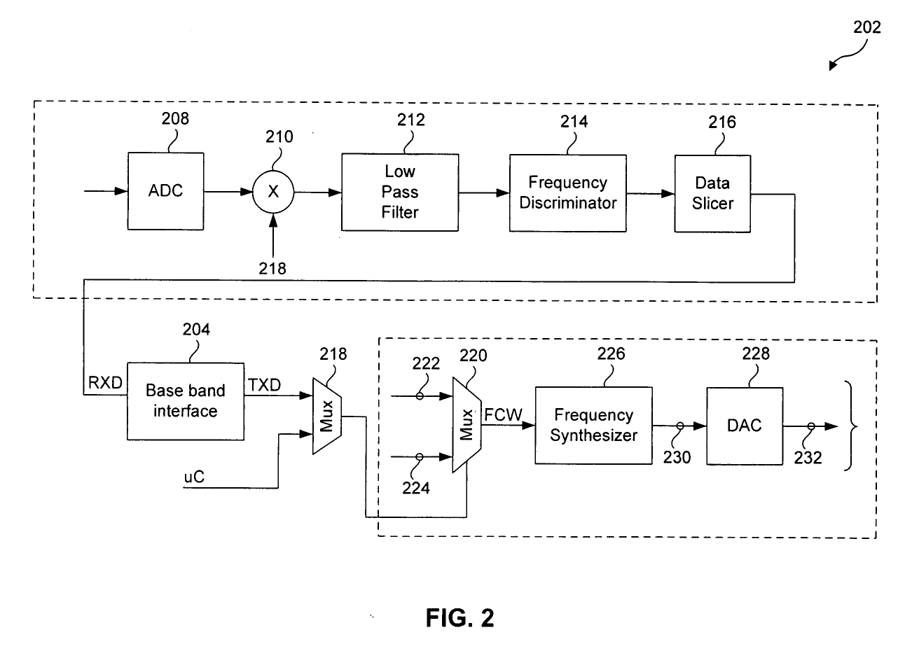

FIG. 2 illustrates an integrated frequency-shift keying (FSK) transceiver 200 constructed in accordance with the present invention. The integrated FSK transceiver 200 uses a binary FSK scheme to provide the fast and reliable bidirectional exchange of information between the set-top box 106 and the ODUs 102-1 through 102-n. The integrated FSK transceiver 200 is fully integrated onto a single integrated circuit (IC) chip, thereby reducing the amount of power consumed, the amount of PCB space required and manufacturing costs. The integrated FSK transceiver 200 can be incorporated into the set-top box 106 and can communicate with translation modules of the ODUs 102-1 through 102-n.

As shown in FIG. 2, the integrated FSK transceiver 200 includes a receiver 202, a baseband interface 204 and a transmitter 206. In this embodiment, the baseband interface 204 is a universal asynchronous receiver/transmitter (UART). As a result, the RS-232 protocol governs the baseband format of the integrated FSK transceiver 200. The integrated FSK transceiver 200 can be modified to support other baseband protocols as will be appreciated by those skilled in the art(s) from the discussion herein.

The receiver 202 includes a one bit analog-to-digital converter (ADC) 208, a mixer 210, a low pass filter (LPF) 212, a frequency discriminator 214 and a data slicer 216. The ADC 208, for example, can include a buffer and a limiter (not shown). The ADC 208 is configured for coupling to one or more of the ODUs 102-1 through 102-n via a coaxial cable. The ADC 208 receives a binary FSK signal centered about a carrier frequency. The ADC 208, on a bit-by-bit basis, determines if an incoming signal is above or below a threshold of zero volts.

An output port of the ADC 208 is coupled to the mixer 210. The mixer uses a local oscillator (LO) signal 234 to down-convert an output of the ADC 208 to baseband. A frequency of the LO 234 is approximately equal to a frequency of the carrier signal carrying the input signal coupled to the ADC 208.

In the embodiment of FIG. 2, the baseband output of the mixer 210 is provided to the LPF 212. The LPF 212 filters the output of the mixer 210. By way of illustration, the LPF 212 has a bandwidth of 200 kHz. In the actual embodiment of FIG. 2, however, the bandwidth of the LPF 212 can be modified to support other baseband signaling protocols as will be appreciated by one skilled in the art(s) from the discussion herein.

The output of the LPF 212 is provided to a frequency discriminator 214. The frequency discriminator 214 generates an output that is proportional to the instantaneous frequency of the input to the frequency discriminator 214.

The output of the frequency discriminator 214 is provided to a data slicer 216. The data slicer 216 includes a decoder/correlator to decode data received from an ODU 102. The data slicer 216 can be modified in accordance with the baseband protocol implemented or supported by the integrated FSK transceiver 200. For RS-232, the data slicer 216 receives a one bit control header and an eight bit payload. The output of the data slicer 216 is a serial data stream that is provided to a receiver interface of the UART 204.

The data slicer 216 is configured to tolerate a significant amount of out of band noise. A correlator, included in the data slicer, allows a high rate of oversampling that substantially reduces this noise. Accordingly, the FSK receiver 202 reduces a need for expensive off-chip pre-filtering of the input to the ADC 208.

The receiver 202, and its constituent components, can also be configured in accordance with the FSK receiver described in co-pending Application Ser. No. 10/952,171, filed Sep. 29, 2004, entitled “Integrated Burst FSK Receiver,” herein incorporated by reference in its entirety.

The UART 204 provides a serial-to-parallel (S/P) interface between the FSK receiver 202 and a microcontroller (or microprocessor) that manages the integrated FSK transceiver 200. Loosely, the UART 204 can be considered a Media Access Control (MAC) device and the FSK receiver 202 and FSK transmitter 206 can be considered Physical Layer Devices (PHYs). The receiver interface of the UART 204 includes a first-in first out (FIFO) buffer. Serial data received from the data slicer 216 is framed into bytes for transmission to the managing microprocessor of the integrated FSK transceiver 200. The UART 204 can also provide the integrated FSK transceiver 200 with connectivity to any other component of the set-top box 106.

The UART 204 also includes a transmitter interface. The transmitter interface of the UART 204 provides a parallel-to-serial (P/S) interface between the microcontroller and the transmitter 206. Both the receiver interface and transmitter interface of the UART 204 are controlled by the microcontroller of the integrated FSK transceiver 200.

To receive data from the UART 204, the microcontroller transmits a first control signal.

Once the control signal is received, the UART 204 provides the contents of the receiver FIFO buffer to the microcontrollers In this way, the microcontroller receives data from the ODU 102. To transmit data to the UART 204, the microcontroller transmits parallel data to a transmit buffer of the UART 204. A second control signal is transmitted by the microcontroller and is used to request the UART 204 to serially convey the contents of the transmit FIFO buffer to the transmitter 206.

The transmitter interface of the UART 204 outputs data to a multiplexer (MUX) 218. A second input to the MUX 218 receives a signal from the microcontroller of the integrated FSK transceiver 200. The microcontroller can therefore override the generation of baseband signals from the UART 204 and send out binary FSK signals generated in software instead.

The output of the MUX 218 is applied to the FSK transmitter 206. As shown in FIG. 2, the transmitter 206 includes a MUX 220, a frequency synthesizer 226 and a digital-to-analog converter (DAC) 228. The output of the MUX 218 controls the MUX 220. The output of the MUX 218 determines the bit rate of the FSK transmitter 206. Since the UART 204 implements the RS-232 protocol, the output of the MUX 218 determines the baud rate of the FSK transmitter 206.

The MUX 220 is used to select between a first tone 222 and a second tone 224.

The first tone is selected when a “0” is received from the MUX 218. The second tone is selected when a “1” is received from the MUX 208. The frequencies of the first and second tones are selected to be sufficiently separate so that they can be differentiated.

The output of the MUX 220 is a frequency control word (FCW) that drives the frequency synthesizer 226. The frequency synthesizer 226 is a direct to digital frequency synthesizer that converts the FCW into a digital sine wave corresponding to a frequency of the FCW. Specifically, when the FCW corresponding to the first tone 222 is selected, the frequency synthesizer 226 generates a digital sine wave of a first frequency. When the FCW corresponding to the second tone 224 is selected, the frequency synthesizer 226 generates a digital sine wave of a second frequency. In essence, the frequency synthesizer 226 can be viewed as providing a carrier signal for the first and second tones 222 and 224.

The output 230 of the frequency synthesizer 226 is a high quality digital signal. Specifically, the output 230 is a ten bit digital signal that is provided to the DAC 228. The DAC 228 is a high quality, ten bit converter that generates a modulated analog sine wave 232. The modulated analog sine wave 232 is provided to the ODU 102 over a coaxial cable. The DAC 228 has a roughly 60 dB spurious free dynamic range (SFDR).

The coaxial cable used to connect the ODU 102 to the integrated FSK transceiver 200 is also used to carry received satellite data and/or media communications. Therefore, the carrier frequency generated by the frequency synthesizer 226 is selected to be sufficiently out of band so that the binary FSK management communication between the integrated FSK transceiver 200 and the ODU 102 does not cause interference. Consequently, the carrier frequency employed by the integrated FSK transceiver 200 can be, for example, 4 MHz, with tone separation, for example, of approximately 50 kHz between the first and second tones 222 and 224.

As an alternative to providing the output of the DAC 232 to the ODU 102, the most significant bit (MSB) of the ten bit output 230 of the frequency synthesizer 226 can be supplied to the ODU 102. The MSB of the output 230 is the sign bit of the digital signal 230 generated by the frequency synthesizer 226. This alternative provides a cruder output signal to an ODU 102 but obviates the need for the high quality DAC 228. The high quality output 232 of the DAC 228, however, can reduce the need for subsequent off-chip filtering of the output signal 232. Therefore, the high costs of off-chip filtering of a crude output signal can be reduced by implementing the DAC 228 on-chip with the integrated FSK transceiver 200.

It is to be appreciated by those skilled in the art(s) from the discussion herein that the FSK transmitter 206 can be configured in accordance with other FSK transmitter architectures. For example, as an alternative to using the frequency synthesizer 226, a numerically controlled oscillator (NCO) can be used to generate the discrete-time, discrete-valued representation of a sinusoidal waveform 230.

As previously mentioned, a microprocessor or microcontroller can be used to control one or more of the constituent components of the integrated FSK transceiver 200. Accordingly, one or more of the constituent components of the integrated FSK transceiver 200 can be coupled to the management microprocessor.

Further, each of the components of the integrated FSK transceiver 200 can be implemented in hardware, software or some combination thereof. In one embodiment, the components of the integrated FSK transceiver 200 depicted in FIG. 2 are each implemented in hardware and controlled by a microprocessor or microcontroller.

The integrated FSK transceiver 200 implements each of the components depicted in FIG. 2 on a single integrated circuit chip. The integrated FSK transceiver 200 reduces manufacturing and operating costs by obviating the need for implementing discrete components on a PCB.

The integrated FSK transceiver 200 enables bidirectional communication between the baseband interface 204 and one or more translation modules of associated antennas. This allows the baseband interface 204 to transmit and receive management, control and/or status information with one or more ODUs 102-1 through 102-n. Further, the integrated FSK transceiver 200 provides a fast and reliable communication link.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

While various embodiments of the present invention have been described above, it should be understood that they have been presented by way of example and not limitation. It will be apparent to one skilled in the pertinent art that various changes in form and detail can be made therein without departing from the spirit and scope of the invention. Therefore, the present invention should only be defined in accordance with the following claims and their equivalents.

What is claimed is:

1. An integrated frequency-shift keying (FSK) transceiver, comprising:
an FSK receiver;
a baseband interface coupled to the FSK receiver; and
an FSK transmitter coupled to the baseband interface;
wherein the FSK receiver, the baseband interface, and the FSK transmitter are formed on a single integrated circuit.

2. The integrated FSK tranceiver of claim 1, wherein the FSK transmitter is coupled to the baseband interface through a multiplexer.

3. The integrated FSK tranceiver of claim 2, wherein the multiplexer is coupled to a microcontroller.

4. The integrated FSK transceiver of claim 1, wherein the FSK receiver includes:
an analog-to-digital converter (ADC);
a mixer coupled to an output of the ADC;
a frequency discriminator coupled to an output of the mixer; and
a data slicer coupled to the baseband interface and to the frequency discriminator.

5. The integrated FSK transceiver of claim 1, wherein the FSK receiver includes:
(a) an analog-to-digital converter (ADC);
(b) a mixer coupled to an output of the ADC;
(c) a low-pass filter coupled to an output of the mixer;
(d) a frequency discriminator coupled to an output of the low-pass filter; and
(e) a data slicer coupled to the baseband interface and also coupled to an output of the frequency discriminator.

6. The FSK receiver of claim 4, wherein the data slicer includes a correlator.

7. The FSK receiver of claim 6, wherein at least one of the mixer, the frequency discriminator, and the data slicer is implemented in a digital signal processor.

8. The integrated FSK transceiver of claim 1, wherein the FSK transmitter includes:
(a) a multiplexer (MUX) coupled to the baseband interface;
(b) a frequency synthesizer coupled to an output of the MUX; and
(c) a digital-to-analog converter with an output to an external device, wherein the digital-to-analog converter is coupled to the frequency synthesizer.

9. The FSK transmitter of claim 8, wherein at least the frequency synthesizer is implemented in a digital signal processor.

10. The integrated FSK transceiver of claim 1, wherein the baseband interface is a universal asynchronous receiver/transmitter (UART).

11. The integrated FSK transceiver of claim 1, wherein the FSK receiver is a binary FSK receiver.

12. The integrated FSK transceiver of claim 1, wherein the FSK transmitter is a binary FSK transmitter

13. A satellite set top box that receives FSK modulated signals comprising an integrated FSK transceiver of claim 1.

14. A cable TV set top box that receives FSK modulated signals comprising an integrated FSK transceiver of claim 1.
